(19) United States
(12) Patent Application Publication
(10) Pub. No.: US 2014/0112727 A1
(43) Pub. Date: Apr. 24, 2014

(54) CUTTING TOOL LOCATING DEVICE FOR FORMING AN OPENING IN A GEAR

(71) Applicant: GENERAL ELECTRIC COMPANY, Schenectady, NY (US)

(72) Inventors: Charles Vaughan Spanos, Mauldin, SC (US); Randall Stephen Corn, Travelers Rest, SC (US); John William Herbold, Fountain Inn, SC (US); James Bradford Holmes, Fountain Inn, SC (US)

(73) Assignee: GENERAL ELECTRIC COMPANY, Schenectady, NY (US)

(21) Appl. No.: 13/658,315

(22) Filed: Oct. 23, 2012

(51) Int. Cl. B23B 45/14; B23B 41/00; F04D 29/56

(52) U.S. Cl. 408/1 R; 408/115 B; 415/151

(57) ABSTRACT

A cutting tool locating device for a forming an opening in a gear includes a guide member configured and disposed to be fixedly connected to gear mounted to a shaft, and an alignment puck moveably mounted to the guide member. The alignment puck includes a bushing configured and disposed to align with a recess formed in the shaft.

### BACKGROUND OF THE INVENTION

The subject matter disclosed herein relates to the art of turbomachines and, more particularly, to a cutting tool locating device for a turbomachine inlet guide vane assembly.

Many turbomachines include a compressor portion linked to a turbine portion through a common compressor/turbine shaft or rotor and a combustor assembly. The compressor portion guides compressed air flow through a number of sequential stages toward the combustor assembly. In the combustor assembly, the compressed air flow mixes with a fuel to form a combustible mixture. The combustible mixture is combusted in the combustor assembly to form hot gases. The hot gases are guided to the turbine portion through a transition piece. The hot gases expand through the turbine portion rotating turbine blades to create work that is output, for example, to power a generator, a pump, or to provide power to a vehicle. In addition to providing compressed air for combustion, a portion of the compressed airflow is passed through the turbine portion for cooling purposes. Generally the compressor portion includes a compressor casing and the turbine portion includes a turbine casing.

In many cases, air enters the compressor portion through an inlet provided with selectively adjustable inlet guide vanes. Generally, the inlet guide vanes include an airfoil portion coupled to a shaft. An angle of attack of the airfoil portion is adjusted by applying a force to the shaft. Each shaft is typically provided with a shaft gear that interacts with a ring gear. Rotation of the ring gear is transmitted to the shaft gear to selectively and collectively position the inlet guide vanes to establish the desired angle of attack for the inlet air entering the compressor.

### BRIEF DESCRIPTION OF THE INVENTION

According to one aspect of the exemplary embodiment, a cutting tool locating device for forming an opening in a gear includes a guide member configured and disposed to be fixedly connected to gear assembly, and an alignment puck moveably mounted to the guide member. The alignment puck includes a bushing configured and disposed to align with a recess formed in the gear assembly.

According to another aspect of the exemplary embodiment, an inlet guide vane (IGV) assembly for a turbomachine includes an airfoil portion, a shaft member extending from the airfoil portion, a gear mounted to the shaft member, and a cutting tool locating device coupled relative to the gear. The cutting tool locating device includes a guide member fixedly connected relative to the shaft member at the gear, and an alignment puck selectively moveably mounted to the guide member. The alignment puck includes a bushing configured and disposed to align with a recess formed in the inlet guide vane shaft.

According to yet another aspect of the exemplary embodiment, a method of locating a cutting tool for forming an opening in a gear includes positioning a guide member over a gear coupled to a shaft, mounting an alignment puck to the guide member, aligning a bushing provided on the alignment puck relative with an opening formed in the shaft, locking the alignment member and guide member relative to the gear, inserting a cutting tool element through the bushing, and forming an opening in the gear that aligns with the opening in the shaft.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial cross-sectional side view of a turbomachine including an inlet guide vane (IGV) assembly in accordance with the prior art;

FIG. 2 is a partial perspective view of the IGV assembly of FIG. 1, illustrating a cutting tool locating device in accordance with an exemplary embodiment;

FIG. 3 is an exploded view of the cutting tool locating device of FIG. 2;

FIG. 4 is a plan view of an IGV gear mounted to an IGV shaft;

FIG. 5 is a plan view of the IGV gear of FIG. 4 rotated about the IGV shaft;

FIG. 6 is a plan view of a base member of the cutting tool locating device in accordance with an exemplary embodiment mounted to the IGV gear of FIG. 5;

FIG. 7 is a plan view of a guide member positioned upon the base member of FIG. 6;

FIG. 8 is a plan view of a coupler member joining the guide member to the base member;

FIG. 9 is a plan view of an alignment puck being secured to the guide member;

FIG. 10 is a plan view of the IGV gear of FIG. 5 having a new opening in accordance with an exemplary embodiment; and

FIG. 11 illustrates a cutting tool actuation device for urging a cutting tool to form an opening in the IGV gear of FIG. 5 in accordance with an aspect of an exemplary embodiment.

The detailed description explains embodiments of the invention, together with advantages and features, by way of example with reference to the drawings.

### DETAILED DESCRIPTION OF THE INVENTION

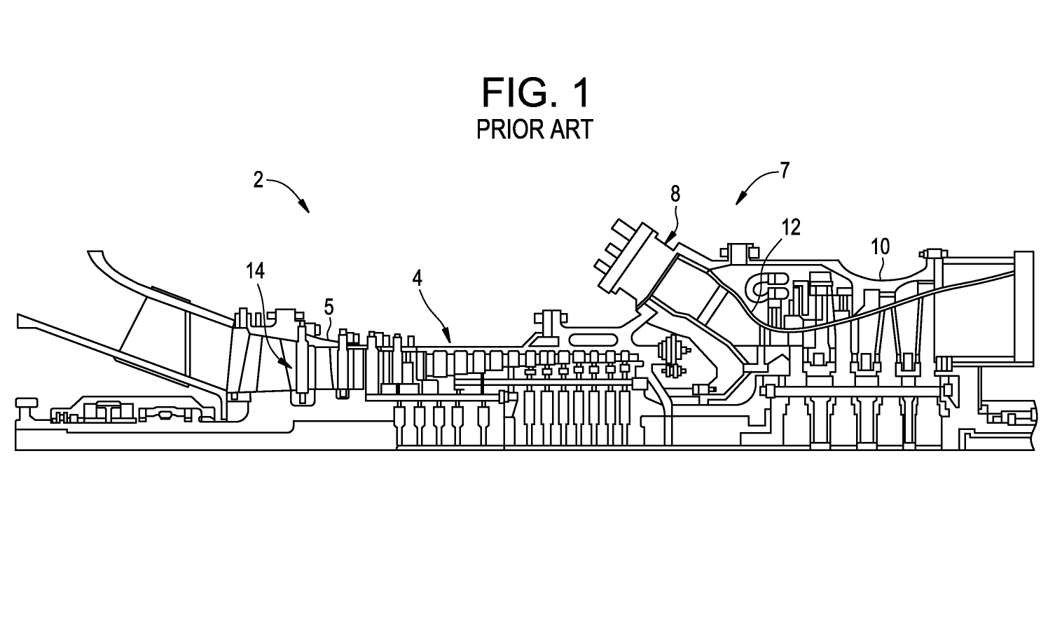

With reference to FIG. 1, a turbomachine constructed in accordance with exemplary embodiments of the invention is generally indicated at 2. Turbomachine 2 includes a compressor portion 4 having a compressor casing 5. Compressor portion 4 is fluidically connected to a combustor assembly 7 having a plurality of combustors, one of which is indicated at 8, arranged in a can-annular array. Of course, it should be understood that other combustor arrangements may also be employed. Combustor assembly 7 is also fluidically connected to a turbine portion 10 through a transition piece 12.

During operation, air flows across inlet guide vanes (IGV), one of which is shown at 14, into compressor portion 4. The air is compressed and passed to combustor 8. At the same time, fuel is passed to combustor 8 to mix with the compressed air to form a combustible mixture. Additional air is employed for cooling in combustor assembly 7 and turbine portion 10. The combustible mixture is combusted to form hot gases that are guided through transition piece 12 into turbine portion 10. Turbine portion 10 converts thermal energy from the combustion gases into mechanical rotational energy that is employed to power a device (not shown).

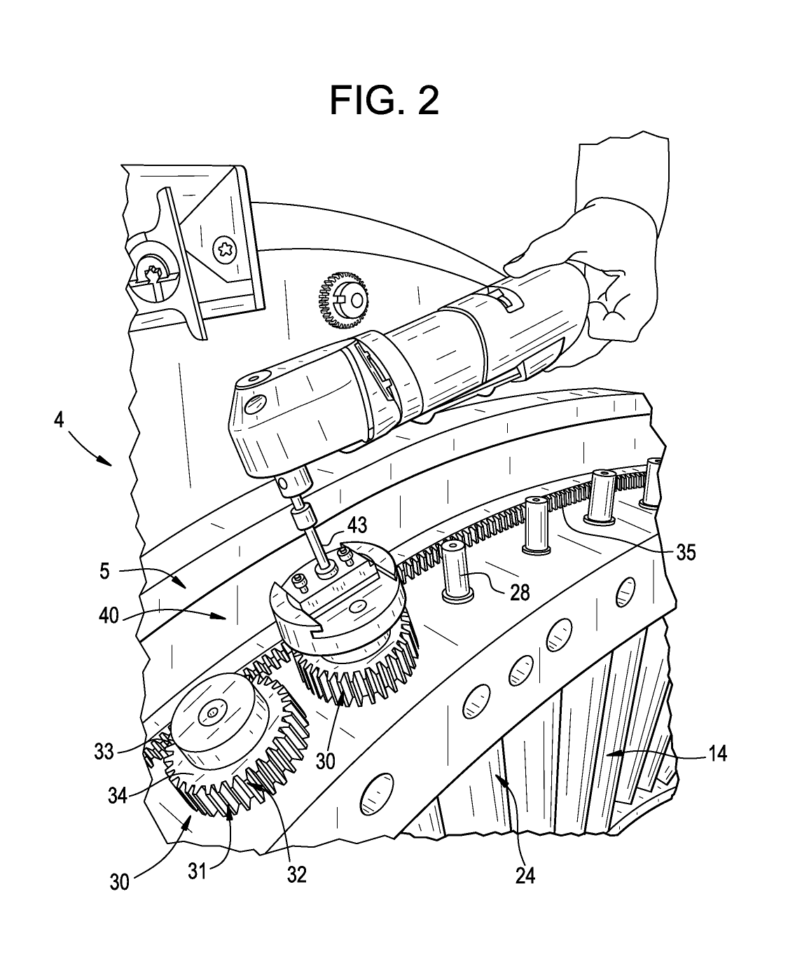

As shown in FIG. 2, each IGV 14 includes an airfoil portion 24 supported by a shaft member 28. Airfoil portion 24 is exposed to inlet air flow while shaft member 28 extends through compressor casing 5. A gear 30 is coupled to shaft member 28. Gear 30 includes a base portion 31 provided with a plurality of gear teeth 32. Base portion 31 extends to a raised, reduced diameter, portion 33 through a step section 34. Each gear 30 is operatively coupled to a ring gear 35. Rotation of ring gear 35 imparts a rotational force to IGVs 14. Over time, gear teeth 32 wear. Worn gear teeth generally lead to a need for repair or replacement of gear 30. Gear 30 completes only a partial rotation when acted upon by ring gear 35. Therefore, indexing or rotating and re-establishing a connection between gear 30 and shaft member 28 will provide a renewed interface with ring gear 35. When indexing gear 30 it is desirable to form a new keyway in reduced diameter portion 33 to facilitate a new connection with shaft member 28. As will be detailed more fully below, a cutting tool locating device 40 is connected to gear 30 to guide a cutting tool 43 into reduced diameter portion 33.

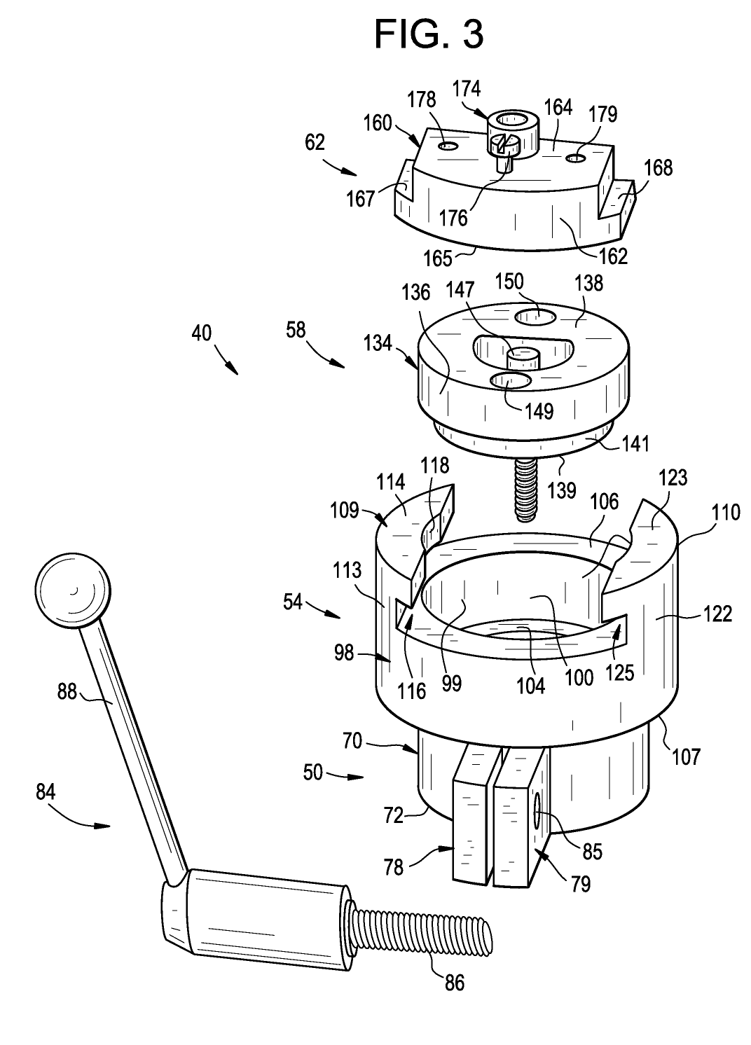

In accordance with an aspect of the exemplary embodiment illustrated in FIG. 3, cutting tool locating device 40 includes a base member 50, a guide member 54, a coupler member 58 and an alignment puck 62. Base member 50 includes a base body 70 having a lower surface 72, an upper surface 73 (FIG. 6) and a central opening 75 (FIG. 6). Lower surface 72 is configured to rest upon step section 34 with central opening 75 receiving reduced diameter portion 33. Base member 50 also includes a first clamping ear 78 and a second clamping ear 79. First and second clamping ears 78 and 79 are urged toward one another to secure base member 50 to reduced diameter portion 33. A mechanical fastener 84 is passed through an opening (not shown) in, for example, first clamping ear 78 and engages with threads (not shown) provided in an opening 85 provided in second clamping ear 79. Mechanical fastener 84 is shown to include a threaded portion 86 that engages with the threads and an operating handle 88.

Base member 50 supports guide member 54. In the exemplary embodiment shown, guide member 54 is secured to base member 50 by coupler member 58 as will be discussed more fully below. It should however be understood that guide member 54 could also be rotationally linked to base member 50. Guide member 54 includes a guide member body 98 having an inner surface 99 that defines a central opening 100. An annular step 104 extends around inner surface 99 within central opening 100. Guide member body 98 includes an upper surface 106 and a lower surface 107. Lower surface 107 rests upon upper surface 73 of base member 50.

Guide member 54 is also shown to include a first flange 109 and an opposing second flange 110. First flange 109 includes a first portion 113 that extends generally perpendicularly from upper surface 106 and a second portion 114. Second portion 114 extends generally perpendicularly from first portion 113 and is spaced from upper surface 106 so as to define a first guide track 116. Second portion 114 is also shown to include a recess 118 having a generally circular shape. Similarly, second flange 110 includes a first portion 122 that extends generally perpendicularly from upper surface 106 and a second portion 123. Second portion 123 extends generally perpendicularly from first portion 122 and is spaced from upper surface 106 so as to define a second guide track 125. Second portion 123 is also shown to include a recess 127 having a generally circular shape.

Coupler member 58 includes a coupler member body 134 that is sized to be received by central opening 100. Coupler member body 134 includes an outer annular edge 136, an upper surface 138 and a lower surface 139 defined by an annular step portion 141. Annular step portion 141 is formed in outer annular edge 136. Coupler member body 134 includes a central opening (not separately labeled) that receives a mechanical fastener 147. Mechanical fastener 147 is configured to engage with a central opening (also not separately labeled) formed in shaft 28. When tightened, mechanical fastener 147 urges coupler member 58 against annular step 104 to clamp guide member 54 against upper surface 73 of base member 50. Coupler member body 134 also includes first and second offset openings 149 and 150 spaced from the central opening. First and second offset openings are arranged to selectively align with shaft 28 as will be discussed more fully below.

Alignment puck 62 includes an alignment puck body 160 having a curvilinear edge 162, an upper surface 164 and a lower surface 165. Alignment puck body 160 also includes a first tab 167 and an opposing second tab 168. First and second tabs 167 and 168 are configured to be received by first and second guide tracks 116 and 125. Alignment puck 62 includes a central opening (not separately labeled) that receives a bushing 174. A fastener 176 is threaded into another opening (not shown) formed in alignment puck body 160 to retain bushing 174. Additional threaded openings 178 and 179 are positioned on either side of bushing 174. Although described as having a curvilinear edge, alignment puck 62 may include various other geometries. Further, it should be understood that instead of employing mechanical fastener 147 to claim guide member 54 to base member 50, a clamping force may be generated through fasteners extending through and operatively engaging with threaded openings 178 and 179.

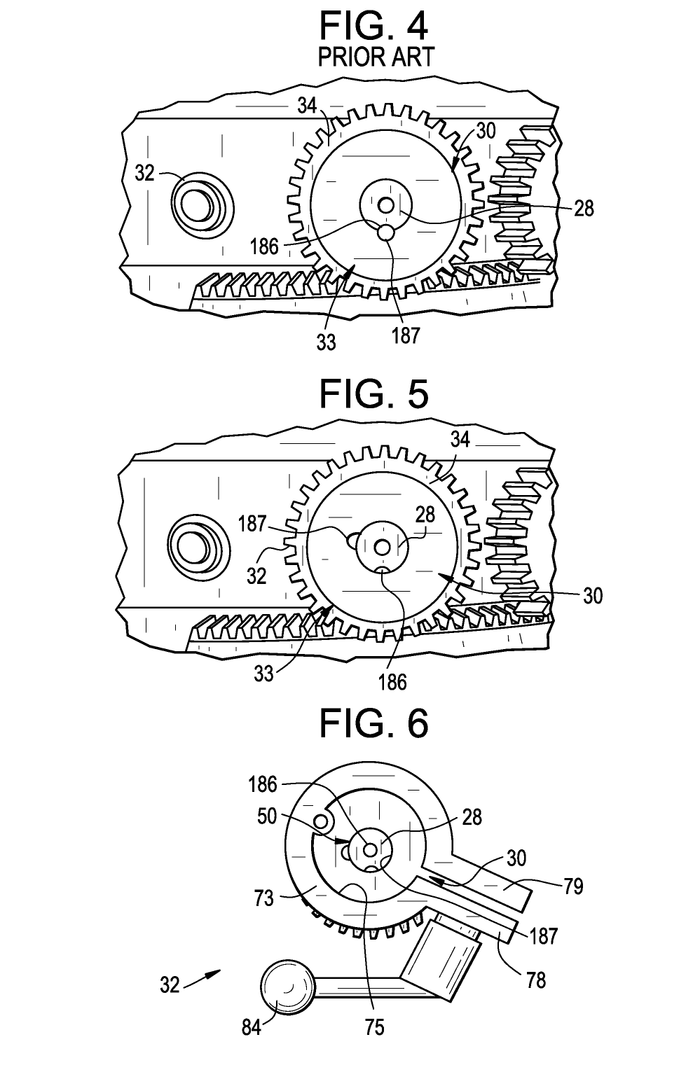

As seen in FIG. 4, shaft 28 includes a first keyway portion 186 and gear 30 includes a second keyway portion 187. First and second keyway portions 186 and 187 are aligned and provided with, for example, a woodruff key to transmit movement of gear 30 to shaft 28. Over time, teeth 32 on gear 30 wear. In order to ensure proper rotation of shaft 28 gear 30 is rotated to expose fresh teeth (not shown) to ring gear 35 as shown in FIG. 5. When gear 30 is rotated, first and second keyway portions 186 and 187 are no longer in alignment. Accordingly, a new keyway portion is formed in gear 30. The new keyway portion is formed by forming an opening in gear 30 that aligns with first keyway portion 186. As will be discussed more fully below, cutting tool locating device 40 is employed to form the new keyway portion.

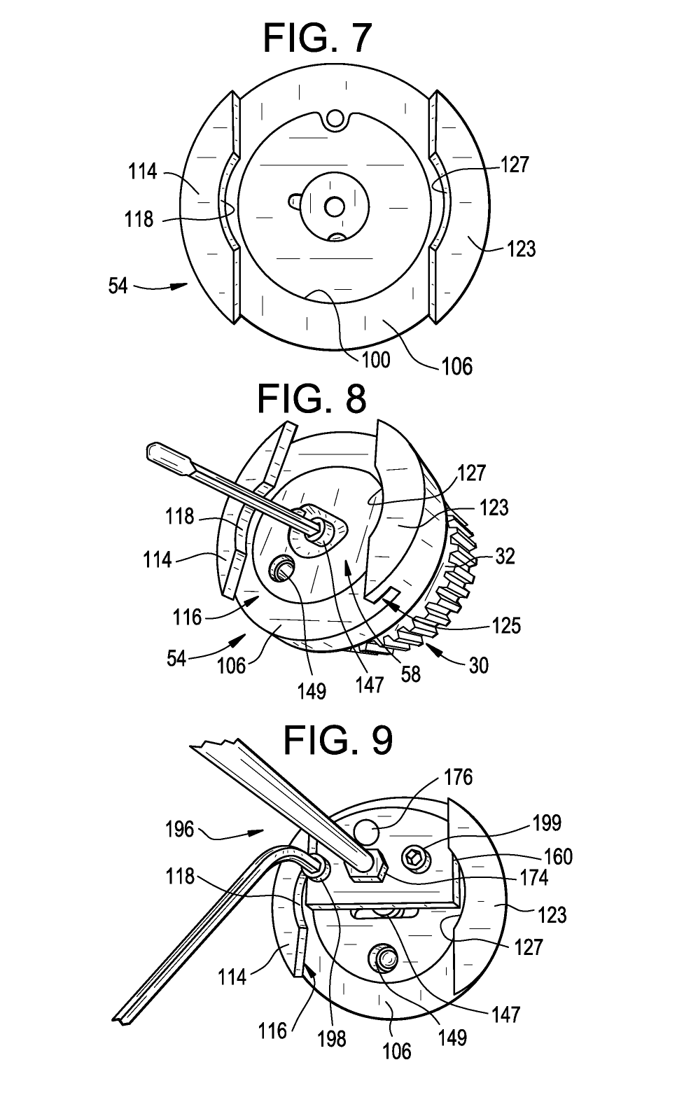

As shown in FIG. 6, base member 50 is mounted to gear 30. More specifically, central opening 75 is positioned about raised, reduced diameter portion 33 with lower surface 72 resting upon step section 34. Mechanical fastener 84 is operated to bring together first and second clamping ears 78 and 79 to affix base member 50 to gear 30. At this point, guide member 54 is positioned upon upper surface 73 and coupler member 58 is positioned within central opening 100 as shown in FIG. 7. Mechanical fastener 147 is threaded into the opening formed in shaft 28 to clamp guide member 54 to base member 50 as shown in FIG. 8. Of course, it should be understood, that guide member 54 may also be clamped directly to gear 34. First and second tabs 167 and 168 are aligned with first and second flanges 109 and 110 and alignment puck 62 is shifted across central opening 100 as shown in FIG. 9.

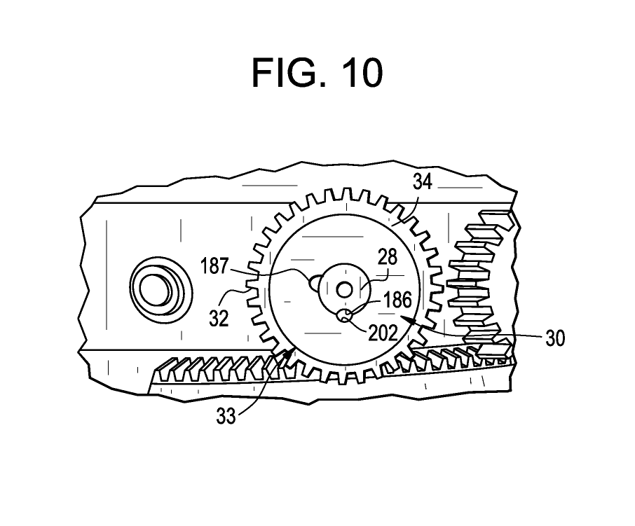

An alignment tool 196 is inserted into bushing 174 and guided into first keyway portion 186. Alignment tool 196 positions keyway portion 186 centrally relative to bushing 174. Alignment puck 62 may be shifted along first and second flanges 109 and 110 to facilitate insertion of alignment tool 196. Additional alignment may be provided by rotating guide member 54. Once alignment tool 196 is inserted into first keyway portion 186, mechanical fasteners 198 and 199 are threaded into threaded openings 178 and 179 and driven into contact with coupler member 58 to lock alignment puck 62 into position. At this point, cutting tool 43, such as a drill bit or the like shown in FIG. 2, may be inserted into bushing 174 and guided into gear 30 to form a new keyway portion 202 as shown in FIG. 10. New keyway portion 202 includes a centerline (not separately labeled) that is substantially aligned with a centerline (also not separately labeled) of first keyway 186.

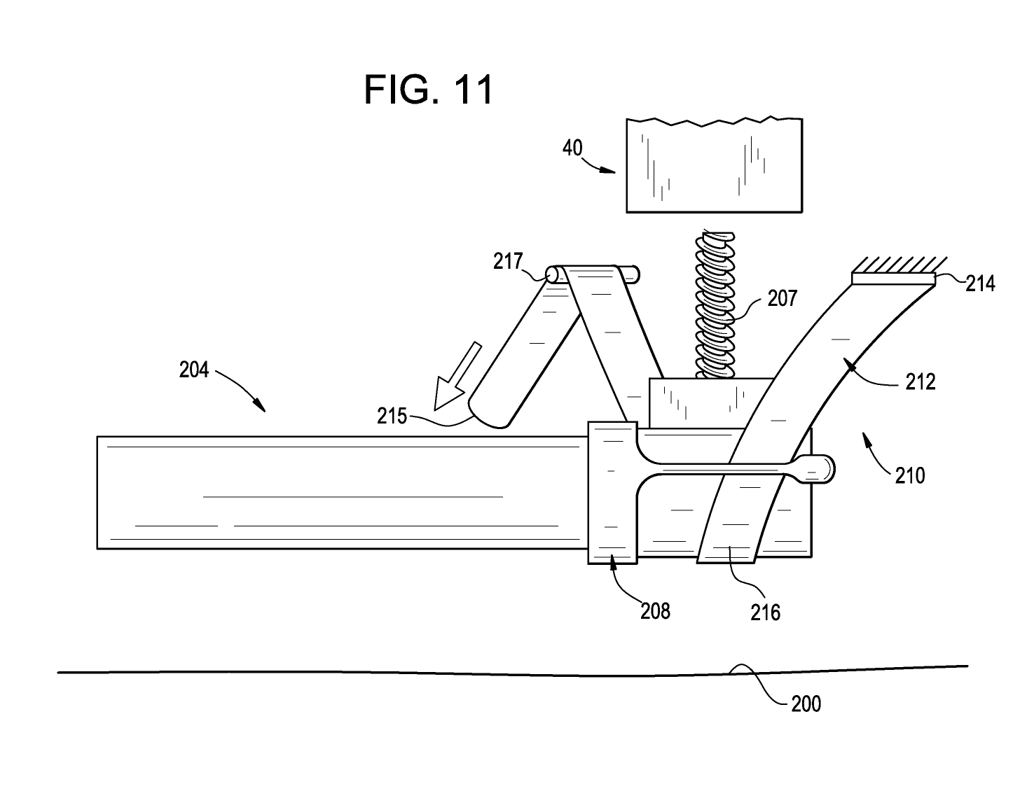

Occasionally, a need arises to form a new keyway portion in a gear that is positioned in an awkward location. As shown in FIG. 11, cutting tool locating device 40 may be positioned at an underside of compressor portion 4 adjacent to a base or support structure 200 leaving little room to manipulate a tool such as shown at 204. Tool 204 supports and rotates a cutting tool 207 such as a drill bit or the like. Cutting tool 207 includes a guide element 208 that provides leverage to guide cutting tool 207 into, for example, gear 30. Guide element 208 includes a leveraging element 210 that takes the form of a strap 212. Strap 212 includes a first end 214 that extends to a second end 215 through an intermediate portion 216. First end 214 is affixed to, for example, compressor casing 5 and intermediate portion 216 is passed over a roller 217. Roller 217 is also affixed to, for example, compressor casing 5. A force is applied to second end 215 causing strap 212 to urge tool 204 toward compressor portion 4 guiding cutting tool 207 into gear 30 to form another keyway portion. In this manner, an operator may employ tool 204 in tighter spaces then would otherwise be possible, or comfortable.

At this point it should be understood that while the exemplary embodiments describe a tool that facilitates alignment of a cutting tool to form a keyway portion in an inlet guide vane gear, the alignment tool may be used to form an opening in a gear associated with any number of a variety of applications. Also, while shown as employing a coupler member joining the guide member to a base, it should be understood that the guide member may be joined directly to the base without use of a separate coupler.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A cutting tool locating device for forming an opening in a gear:
a guide member configured and disposed to be fixedly connected to a gear coupled to a shaft; and
an alignment puck moveably mounted to the guide member, the alignment puck including a bushing configured and disposed to align with a recess formed in the shaft.

2. The cutting tool locating device according to claim 1, further comprising: a base member configured and disposed to fixedly connect to the gear, the base member including a surface for supporting the guide member.

3. The cutting tool locating device according to claim 2, further comprising: a coupler member having a mounting feature configured and disposed to secure the coupler member to the shaft.

4. The cutting tool locating device according to claim 3, wherein the guide member include a central opening having an annular step, the coupler member nesting within the central opening and resting upon the annular step.

5. The cutting tool locating device according to claim 4, wherein guide member is fixedly connected to the gear through the coupler member.

6. The cutting tool locating device according to claim 2, wherein the base member includes first and second clamping ears configured and disposed to fixedly connect the base member to the gear.

7. The cutting tool locating device according to claim 1, wherein the guide member includes a first flange defining a first guide track and a second flange defining a second guide track, the alignment puck being moveably mounted to the first and second guide tracks.

8. The cutting tool locating device according to claim 7, wherein the alignment puck includes a mechanical fastener, the bushing being secured to the alignment puck through the mechanical fastener.

9. The cutting tool locating device according to claim 1, wherein the alignment puck includes a mechanical fastener configured and disposed to lock the alignment puck relative to the guide member.

10. The cutting tool locating device according to claim 1, further comprising: a cutting tool configured and disposed to pass through the bushing to form an opening in the gear.

11. An inlet guide vane (IGV) assembly for a turbomachine comprising:
an airfoil portion;
a shaft member extending from the airfoil portion;
a gear mounted to the shaft member; and
a cutting tool locating device comprising:
a guide member fixedly connected relative to the shaft member at the gear; and
an alignment puck moveably mounted to the guide member, the alignment puck including a bushing configured and disposed to align with a recess formed in the IGV assembly.

12. The IGV assembly according to claim 11, further comprising: a base member supported by the gear over the shaft member, the base member including a surface for supporting the guide member.

13. The IGV assembly according to claim 12, further comprising: a coupler member fixedly mounted to the shaft member, the coupler member joining the guide member to the base member.

14. The IGV assembly according to claim 11, wherein the alignment puck includes a mechanical fastener, the bushing being detachably mounted to the alignment puck through the mechanical fastener.

15. The IGV assembly according to claim 11, wherein the alignment puck includes a mechanical fastener configured and disposed to lock the alignment puck relative to the guide member.

16. A method of locating a cutting tool for forming an opening in a gear, the method comprising:
positioning a guide member over a gear coupled to a shaft;
mounting an alignment puck to the guide member;
aligning a bushing provided on the alignment puck relative with an opening formed in the shaft;
locking the alignment puck and guide member relative to the gear;
inserting a cutting tool element through the bushing; and
forming an opening in the gear that aligns with the opening in the shaft.

17. The method of claim 16, wherein the opening is formed in an inlet guide vane gear positioned at a lower portion of a compressor casing adjacent a support structure.

18. The method of claim 16, wherein locking the guide member includes:
positioning a coupler member in a recess formed in the guide member;
abutting the coupler member with a step section extending about the recess; and
connecting the coupler member to the shaft.

19. The method of claim 18, wherein locking the alignment puck includes passing a mechanical fastener through the alignment puck into contact with the coupler member.

20. The method of claim 16, wherein locking the guide member includes clamping the guide member to the gear.
